(19) United States
(12) Patent Application Publication
(10) Pub. No.: US 2012/0166188 A1
(43) Pub. Date: Jun. 28, 2012

(54) SELECTIVE NOISE FILTERING ON VOICE COMMUNICATIONS

(75) Inventors: Al Chakra, Apex, NC (US); Simon Peter O'Doherty, Dublin (IE)

(73) Assignee: INTERNATIONAL BUSINESS MACHINES CORPORATION, Armonk, NY (US)

(21) Appl. No.: 12/979,531

(22) Filed: Dec. 28, 2010

(51) Int. Cl. G10L 21/02

(52) U.S. Cl. 704/226; 704/E21.002

(57) ABSTRACT

Embodiments of the invention may provide the ability to selective filter sound from a voice communication, such as a telephone call, based on one or more attributes of the voice communication. Embodiments of the invention may select a filtering profile corresponding to the one or more attributes, and filter sound from the voice communication according to the selected profile. In one embodiment of the invention, the one or more attributes of the voice communication are determined from an electronic record corresponding to the voice communication, such as a calendar entry.

### BACKGROUND

The present invention relates to noise filtering, and more particularly to selectively filtering noise on voice communications, such as telephone calls.

Extraneous noise, such as background noise, is often a distracting problem when on a telephone call. This is especially true for a caller who works at home and who participates in important work-related calls from home. For example, such a caller might have children and pets at home that make noises when the caller is participating in a work-related call. There are existing microphone systems that use noise cancelling technology to remove unwanted noise, but such systems cannot always filter the noise appropriately.

### BRIEF SUMMARY

In one embodiment of the invention, a method for selectively filtering noise on a voice communication comprises determining one or more attributes of the voice communication from an electronic record corresponding to the voice communication, and filtering sound from the voice communication according to a selected profile that corresponds to the one or more attributes. The electronic record corresponding to the voice communication is selected from the group consisting of a calendar entry, an email message, a text message, a website entry, or an invite web service.

The one or more attributes of the voice communication may be selected from the group consisting of type of voice communication, time of day of the voice communication, day of week of the voice communication, date of the voice communication, number of participants in the voice communication, type of participants in the voice communication, telephone number of one or more of participants in the voice communication, and location of one or more of participants in the voice communication.

The step of filtering sound from the voice communication may occur at one of (a) a sending end, (b) along a transmitting network, or (c) at a receiving end.

The method may further comprise sampling sound from one or more sources, such that filtering sound from the voice communication comprises comparing the sound from the voice communication to the sampled sound.

Filtering sound from the voice communication may comprise (a) separating sound from the voice communication into discrete sounds, (b) comparing the discrete sounds against previously stored sound samples, (c) applying one or more voice recognition techniques to the discrete sounds to convert the discrete sounds into discrete text, and (d) comparing the discrete text against a linguistic dictionary.

In addition to the method of selectively filtering noise on a voice communication, as described above, other aspects of the present invention are directed to corresponding systems and computer program products for selectively filtering noise on a voice communication.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a telephone system in which embodiments of the present invention may operate;

FIG. 2 is a schematic block diagram of a system and method for selectively filtering noise on a voice communication, in accordance with embodiments of the present invention; and

FIG. 3 is a schematic block diagram of a computer in the system of FIG. 1.

### DETAILED DESCRIPTION

Embodiments of the invention may provide the ability to selectively filter sound from voice communications, such as telephone calls, including but not limited to voice over internet protocol (VoIP) calls. While embodiments of the invention will be described herein in relation to telephone calls, including VoIP calls, embodiments of the invention are capable of filtering sound from any voice communication. Any references herein to a “telephone” are intended to encompass any VoIP-capable device, any analog telephone, any mobile/cellular telephone, or any device capable of providing telephony or voice communication. Further, any references herein to a “telephone call” or “voice communication” are intended to encompass any transmitted voice communication, whether by VoIP, PSTN, mobile/cellular communications, radio frequency, or any other method for transmitting sound.

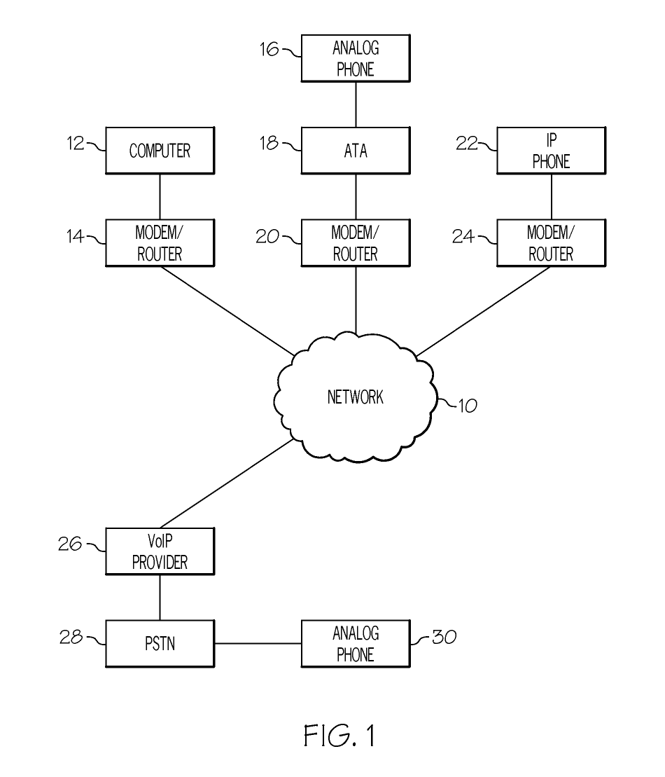

FIG. 1 is a schematic block diagram of a telephone system in which embodiments of the present invention may operate. The system of FIG. 1 includes both VoIP systems and components and public switched telephone network (PSTN) systems and components. VoIP calls can be placed from or to several different types of equipment, three of which are illustrated in FIG. 1. VoIP calls can be placed from or to a computer 12 operatively connected via a modem and/or router 14 to a communications network 10 (e.g., the internet). Computer 12 would typically require a microphone and a speaker to effectively function as a VoIP telephone. Alternatively, VoIP calls can be placed from or to a standard analog telephone 16 which is operatively connected to an analog telephone adapter (ATA) 18. The ATA 18 is in turn operatively connected to network 10 via modem/router 20. The ATA enables the analog telephone to place and receive VoIP calls. In a further alternative, VoIP can be placed from or to an IP (internet protocol) phone 22 that can operatively connect directly to network 10 via modem/router 24 without the need for an ATA. VoIP calls placed from or to one of the three different VoIP systems of FIG. 1 are typically routed across network 10 through a VoIP provider 26.

VoIP calls placed from one of the three different types of VoIP systems of FIG. 1 may be placed to any of the three different types of VoIP systems of FIG. 1. Also, VoIP calls placed from one of the three different types of VoIP systems of FIG. 1 may be placed to an analog telephone 30 on the public switched telephone network (PSTN) 28, by way of a VoIP provider 26.

Communications network 10 can be part of the internet, a worldwide collection of computers, networks, and gateways that currently use the TCP/IP suite of protocols to communicate with one another. The internet provides a backbone of high-speed data communication lines between major nodes or host computers, comprising thousands of commercial, government, educational, and other computer networks, that route data and messages. However, embodiments of the invention may utilize any suitable communication network. In addition to the arrangement of FIG. 1, embodiments of the invention may operate in any networked arrangement in which telephone calls are placed and received and/or in which display elements, data, and/or other information are sent from a source to a recipient. For example, embodiments of the invention may operate in a mobile communications/data architecture (such as a mobile telecommunications network adhering to the International Mobile Telecommunications-2000 (also termed 3G) standards), in which a mobile telecommunications device (e.g., cell/mobile telephone) is the recipient.

Embodiments of the invention may provide the ability to selective filter sound from a telephone call based on one or more attributes of the telephone call. Embodiments of the invention may select a filtering profile corresponding to the one or more attributes, and filter sound from the telephone call according to the selected profile. In one embodiment of the invention, the one or more attributes of the telephone call are determined from an electronic record corresponding to the telephone call. Such an electronic record may be, for example, a calendar entry, an email message, a text message, a website entry (such as on a wiki page), or invite web service. For example, a user of embodiments of the invention may use calendar/scheduling software, such as Lotus Notes from IBM Corporation or Outlook from Microsoft Corporation. Such a user may create a calendar entry for a scheduled telephone call (the telephone call may have two participants or more than two participants (typically termed a conference call); one of the participants may be a recording, such as of an earlier broadcast and recorded presentation). Such a calendar entry may contain information/data regarding the one or more attributes of the planned telephone call, and/or may contain information/data from which one or more attributes of the planned telephone call may be inferred. Such information/data may be available to embodiments of the invention.

For example, the calendar entry or other electronic record may contain the names and telephone numbers of the participants. Further information about the participants may be contained in the calendar software or in a related software module or package (such as a contact manager), which may also be available to embodiments of the invention. For example, the contact manager software may contain categorization information regarding the participants, such as whether a participant is a friend, family member, co-worker, manager, or client of the user. From this information regarding the participants, it may be inferred whether the scheduled call is a business call or a personal call. Alternatively, the calendar software may enable a user to directly indicate whether an entry in the calendar is personal or business related. Additionally, the calendar entry will typically have the date, time, duration, and day of the week of the scheduled call. From this information regarding the day and time of the scheduled call, it may be inferred whether the scheduled call is a business call or a personal call. The calendar entry or other electronic record (possibly in conjunction with the contact manager) may contain information regarding the location of the user and the other participants. The calendar entry or other electronic record may contain information regarding the telephone numbers of the user and the other participants. The calendar entry or other electronic record may contain information regarding whether the scheduled call is “live” (i.e., all participants in the call will be on the call at the same time) or recorded (i.e., at least one participant is a recording).

Embodiments of the invention may then select a filtering profile that corresponds to the one or more attributes of the call. Such filtering profiles may be established in advance and stored in memory. The filtering profiles determine how much and what sounds are filtered from the telephone call, and/or whether any filtering is performed at all. In a simple example, there may be a personal profile and a business profile. In this example, if the embodiments of the invention determine that the telephone call is personal (by determining, for example, that all participants are family and/or friends) then the personal profile may be selected. The personal profile might, for example, not filter out any human voices but may filter out other extraneous noise (the filtering process is described in more detail below). Alternatively, if the embodiments of the invention determine that the telephone call is work related (by determining, for example, that the other participants are clients and/or co-workers) then the business profile may be selected. The business profile might, for example, filter out all extra noises from the caller's telephone except for the caller's clear voice.

Embodiments of the invention may be trained to recognize specific voices and/or noises by pre-recording samples of those voices/noises and storing those samples. For example, a user may pre-record samples of the user speaking, of the user's child yelling, and/or of the user's dog barking. Such samples enable embodiments of the invention to more readily recognize specific voices/noises and filter or allow as appropriate. Such samples also enable embodiments of the invention to factor specific voices/noises into the profiles. For example, the personal profile described above might indicate that John's (the user) voice and Sue's (John's daughter) voice (both of which would have been sampled and recorded) would be allowed but the barking of John's dog (which also would have been sampled and recorded) would be filtered. Similarly, the business profile described above might indicate that John's voice would be allowed but Sue's voice and the barking of John's dog would be filtered.

In alternative embodiments of the invention, the profile might not be selected automatically as described above, but rather the user might manually select a profile to be applied to a particular call. Such a selection might be made by the user in advance (such as by selecting the profile in the calendar entry corresponding to the telephone call) or might be made as the call is commencing or any time during the duration of the call. The user might also be able to manually de-select a profile or in some other manner stop the filtering of a call made as the call is commencing or any time during the duration of the call. The user might also be able to change the selected profile made as the call is commencing or any time during the duration of the call. If the profile is automatically selected by embodiments of the invention, the user might be able to view the automatic selection and change/override the automatic selection if desired.

Embodiments of the invention may enable the step of filtering sound from the telephone call to occur at the sending end, along a transmitting network, or at the receiving end. The hardware and/or software for implementing embodiments of the invention may be contained in a device that is facilitating the VoIP phone call, such as, computer 12, ATA 18, or IP phone 22. Alternatively, the hardware and/or software for implementing embodiments of the invention may be contained in a separate device that is operatively connected to a device that is facilitating the VoIP phone call, such as, computer 12, ATA 18, or IP phone 22. As a further alternative, embodiments of the invention might be implemented by a VoIP provider 26.

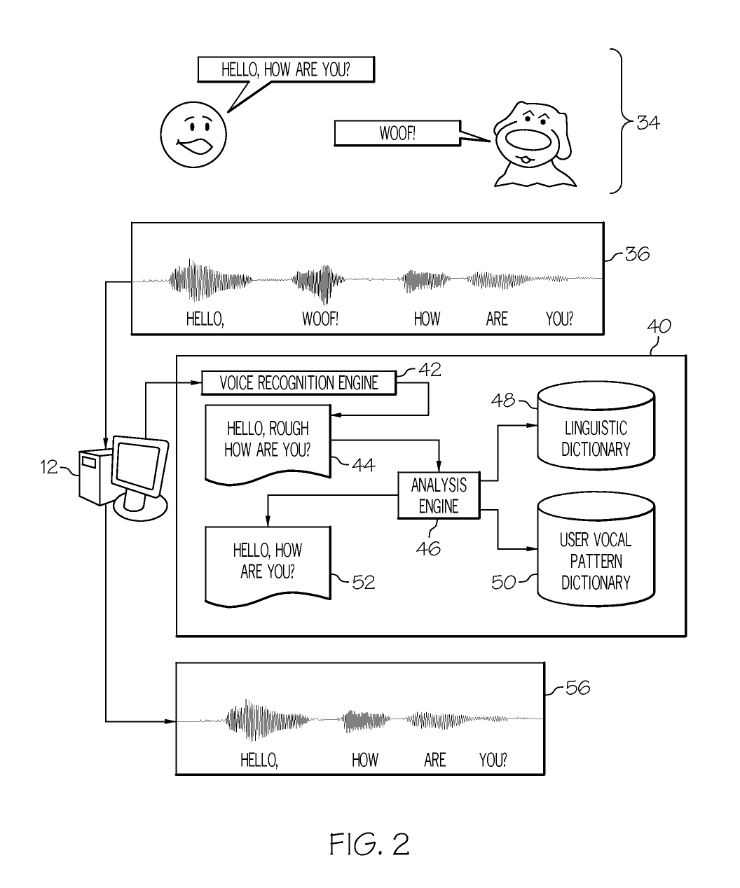

FIG. 2 is a schematic block diagram of a system and method for selectively filtering noise on a telephone call, in accordance with embodiments of the present invention. Element 34 of FIG. 2 illustrates sound that may be picked up by a telephone handset or a computer microphone on the sending end of a telephone conversation. (Alternatively, if the illustrated process is occurring at the receiving end, the unfiltered sound may be transmitted over network 10 to the recipient where the sound is filtered. As a further alternative, if the illustrated process is occurring at a point along the communication network, the unfiltered sound may be transmitted over network 10 to the filtering point where the sound is filtered.) FIG. 2 illustrates that the caller saying “Hello, how are you?” and the caller's dog barking are both picked up by a microphone of computer 12 (or whatever device is functioning as the VoIP telephone), as indicated by element 36 which shows a spectrogram of both the caller's voice and the dog bark (the text included in element 36 is for illustration only—the spectrogram would not include such text).

The received sound, which contains multiple sound sources, may be passed to a filtering device 40 according to embodiments of the invention (which is illustrated in FIG. 2 as being separate from computer 12, but which may be incorporated within computer 12). Filtering device 40 may comprise a voice recognition engine 42 which may break the received sound into discrete sounds and apply known voice recognition techniques. The voice recognition engine 42 might, for example, interpret the received sound as “Hello, rough how are you?” as shown in voice recognition output 44.

The received sound and the text output from the voice recognition engine might be passed onto an analysis engine 46. The analysis engine 46 may attempt to refine the words further by looking for common noises and overlapping noises. The analysis engine may compare the sounds against pre-recorded user vocal patterns and other pre-recorded sounds stored in a user vocal pattern dictionary 50 to help determine which sound is from the speaker and which is background noise. The analysis engine may put a weight onto each word in the sentence. For example, if a dog barks for the first time and the filtering device reacts by removing/filtering that sound, the filtering device may store that sound and assign a weight number 1. That sound bit may be stored at the top of a hash table for potential sounds to be deleted within the applied profile. In this example, if the bark occurs again, the deletion may occur without the full analysis needing to be performed. Similarly, if a sound requires analysis the subsequent time it occurs (for example, if the same sound occurs again, but the user is using a different profile then the sound may need analysis a subsequent time), the sound may get assigned a weight of 10 (i.e., a lower priority ranking). This lower ranking may force the filtering device to make the decision again to ensure that the sound is indeed not a part of the conversation. In addition to the realtime learning, the filtering device could retrieve stored hash tables corresponding to pre-recorded sounds which had weights assigned from previous conversations. The filtering device could reuse such weights when reacting to identical sounds and within an identical profile. This weight system enables a quicker response to enable realtime filtering.

The analysis engine may also check the words and the sentence structure against a linguistic dictionary 48 to help determine if the sentence structure and grammar are correct and if the sentence context is appropriate in relation to the speaker (which may be based on information about the speaker, such as the speaker's occupation, which could provide an indication of what words the speaker might be expected to use). The analysis engine may be able to determine that “rough” (the dog barking) does not belong and filters out that sound, as shown in analysis engine output 52. The analysis engine may determine this by determining that the sound does not match the caller's voice, by determining that the word “rough” does not fit in the sentence, or by a combination of those and other determinations. The output of the analysis engine 52 is passed back to the computer 12 (or other VoIP telephone device). The filtered sound 56 may be sent over network 10 to the recipient (if the illustrated process is occurring at the sending end or along the network) or the filtered sound may be played over a speaker operatively connected to computer 12 (if the illustrated process is occurring at the receiving end).

Embodiments of the invention may utilize one or more modes or settings for determining how the filtered sound is presented to a recipient. For example, three modes might be utilized as follows: (a) an “as-is” mode might not remove any sounds but rather display a textual translation of all of the transmitted sound; (b) a “cautious” mode might not remove any sounds but rather lower the volume of the sounds that are determined to be potentially unwanted; or (c) a “remove” mode might completely remove the sounds that are determined to be unwanted. A visual indicator may be provided to show that noise was removed.

As discussed above, a user may teach embodiments of the invention to recognize the user's voice and other voices/noises by pre-recording samples. Embodiments of the invention may also be able to learn voices while a telephone call is in progress (“on the fly”), and apply what has been learned later in the telephone call or to remove sounds/noise from a recording of the call at a later time (which may be desirable if the recording of the call is to be made available for others to listen to later). Embodiments of the invention might use information regarding the telephone call and/or information regarding the participants to learn voices on the fly. For example, embodiments of the invention might know that three participants are scheduled to participate in the call. Even if none of the participants' voices have been pre-recorded, embodiments of the invention might learn the voices by recognizing three dominant voice patterns on the call and using that information to filter out voices or noises that do not correspond to the three dominant voices. In another example, embodiments of the invention might know that one of the participants scheduled to participate in the call is an attorney. Even if the attorney's voice has not been pre-recorded, embodiments of the invention might learn the attorney's voice by comparing the voice-recognized words to a legal dictionary. In that way, embodiments of the invention might learn to associate one particular speaker's voice with the attorney-participant. If the voices of participants other than the user are to be recorded, a warning device (beep or request to allow) may be used to inform the participants of the recording.

Embodiments of the invention might be used during a conference call (such as might be coupled with a web presentation) to enable listeners' questions to be filtered out during the speaker's presentation but recorded to be played back at a more appropriate time. Thus, a listener could ask a question at any point (rather than having to remember the question and ask during a question-and-answer period) without interrupting the presentation. The point in the presentation at which the question is asked could be marked to enable the speaker to know what the question is referring to. The speaker can play these questions back for the whole group at an appropriate stopping time rather than interrupting the presentation.

Embodiments of the invention could send sounds from a sender which are not filtered but which are tagged with inaudible metadata to enable a recipient to filter the sounds if desired. For example, the sender's voice and background noise at the sender's location could be tagged separately to enable the recipient to more easily filter out the background noise. Alternatively, all voices from all participants could be tagged separately to enable any recipient to selectively filter any one or more speaker's voice.

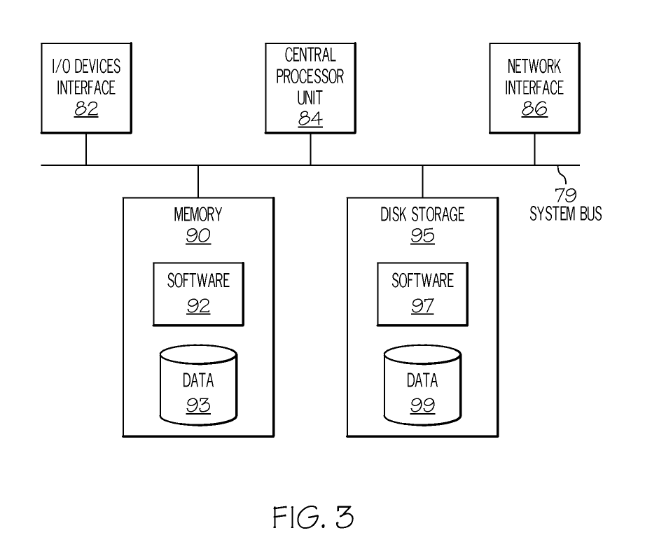

FIG. 3 is a diagram of the internal structure of a computer (e.g., computer 12) in the system of FIG. 1. Each computer typically contains system bus 79, where a bus is a set of hardware lines used for data transfer among the components of a computer. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., displays, printers, speakers, microphones, etc.) to the computer. Network interface 86 allows the computer to connect to various other devices attached to a network (e.g., network 10 of FIG. 1). Memory 90 provides volatile storage for computer software instructions 92 and data 94 used to implement an embodiment of the present invention. Disk storage 95 provides non-volatile storage for computer software instructions 97 and data 99 used to implement an embodiment of the present invention. Central processor unit 84 is also attached to system bus 79 and provides for the execution of computer instructions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

“Computer” or “computing device” broadly refers to any kind of device which receives input data, processes that data through computer instructions in a program, and generates output data. Such computer can be a hand-held device, laptop or notebook computer, desktop computer, minicomputer, mainframe, server, cell phone, personal digital assistant, other device, or any combination thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A method for selectively filtering sound from a voice communication, the method being implemented by a computer, the method comprising:
determining one or more attributes of the voice communication from an electronic record corresponding to the voice communication; and
filtering sound from the voice communication according to a selected profile that corresponds to the one or more attributes.

2. The method of claim 1, wherein the electronic record corresponding to the voice communication is selected from the group consisting of a calendar entry, an email message, a text message, a website entry, or an invite web service.

3. The method of claim 2, wherein the one or more attributes of the voice communication are selected from the group consisting of type of voice communication, time of day of the voice communication, day of week of the voice communication, date of the voice communication, number of participants in the voice communication, type of participants in the voice communication, telephone number of one or more of participants in the voice communication, and location of one or more of participants in the voice communication.

4. The method of claim 1, wherein the profile is selected in the electronic record corresponding to the voice communication.

5. The method of claim 1, wherein the step of filtering sound from the voice communication occurs at one of (a) a sending end, (b) along a transmitting network, or (c) at a receiving end.

6. The method of claim 1, further comprising:
sampling sound from one or more sources;
wherein filtering sound from the voice communication comprises comparing the sound from the voice communication to the sampled sound.

7. The method of claim 1, wherein filtering sound from the voice communication comprises:
separating sound from the voice communication into discrete sounds;
comparing the discrete sounds against previously stored sound samples;
applying one or more voice recognition techniques to the discrete sounds to convert the discrete sounds into discrete text; and
comparing the discrete text against a linguistic dictionary.

8. A system for selectively filtering sound from a voice communication comprising:
a processor configured for (a) determining one or more attributes of the voice communication from an electronic record corresponding to the voice communication, and (b) filtering sound from the voice communication according to a selected profile that corresponds to the one or more attributes.

9. The system of claim 8, wherein the electronic record corresponding to the voice communication is selected from the group consisting of a calendar entry, an email message, a text message, a website entry, or an invite web service.

10. The system of claim 9, wherein the one or more attributes of the voice communication are selected from the group consisting of type of voice communication, time of day of the voice communication, day of week of the voice communication, date of the voice communication, number of participants in the voice communication, type of participants in the voice communication, telephone number of one or more of participants in the voice communication, and location of one or more of participants in the voice communication.

11. The system of claim 8, wherein the profile is selected in the electronic record corresponding to the voice communication.

12. The system of claim 8, wherein the processor filters sound from the voice communication at one of (a) a sending end, (b) along a transmitting network, or (c) at a receiving end.

13. The system of claim 8, wherein the processor is further configured for sampling sound from one or more sources; and wherein filtering sound from the voice communication comprises comparing the sound from the voice communication to the sampled sound.

14. The system of claim 8, further comprising:
a linguistic dictionary; and
a sound pattern dictionary;
wherein filtering sound from the voice communication comprises:
separating sound from the voice communication into discrete sounds;
comparing the discrete sounds against previously stored sound samples in the sound pattern dictionary;
applying one or more voice recognition techniques to the discrete sounds to convert the discrete sounds into discrete text; and
comparing the discrete text against the linguistic dictionary.

15. A computer program product for selectively filtering sound from a voice communication, the computer program product comprising a computer readable storage medium having computer readable program code embodied therewith, the computer readable program code comprising:
computer readable program code configured for determining one or more attributes of the voice communication from an electronic record corresponding to the voice communication; and
computer readable program code configured for filtering sound from the voice communication according to a selected profile that corresponds to the one or more attributes.

16. The computer program product of claim 15, wherein the electronic record corresponding to the voice communication is selected from the group consisting of a calendar entry, an email message, a text message, a website entry, or an invite web service.

17. The computer program product of claim 16, wherein the one or more attributes of the voice communication are selected from the group consisting of type of voice communication, time of day of the voice communication, day of week of the voice communication, date of the voice communication, number of participants in the voice communication, type of participants in the voice communication, telephone number of one or more of participants in the voice communication, and location of one or more of participants in the voice communication.

18. The computer program product of claim 15, wherein the profile is selected in the electronic record corresponding to the voice communication.

19. The computer program product of claim 15, wherein the computer readable program code configured for filtering sound from the voice communication filters sound from the voice communication at one of (a) a sending end, (b) along a transmitting network, or (c) at a receiving end.

20. The computer program product of claim 15, further comprising:
computer readable program code configured for sampling sound from one or more sources;
wherein the computer readable program code configured for filtering sound from the voice communication comprises computer readable program code configured for comparing the sound from the voice communication to the sampled sound.

21. The computer program product of claim 15, wherein the computer readable program code configured for filtering sound from the voice communication comprises:
computer readable program code configured for separating sound from the voice communication into discrete sounds;
computer readable program code configured for comparing the discrete sounds against previously stored sound samples;
computer readable program code configured for applying one or more voice recognition techniques to the discrete sounds to convert the discrete sounds into discrete text; and
computer readable program code configured for comparing the discrete text against a linguistic dictionary.
